(19) United States
(12) Patent Application Publication
(10) Pub. No.: US 2010/0107223 A1
(43) Pub. Date: Apr. 29, 2010

(54) Network Access Method, System, and Apparatus

(75) Inventor: Ruobin ZHENG, Shenzhen (CN)

Correspondence Address: FutureWei Technologies, Inc.;IPR & Standards Department, 1700 Alma Drive, Suite 500, Plano, TX, 75075, US

(73) Assignee: HUAWEI TECHNOLOGIES CO., LTD., Shenzhen (CN)

(21) Appl. No.: 12/649,873

(22) Filed: Dec. 30, 2009

Related U.S. Application Data
(63) Continuation of application No. PCT/CN2008/071506, filed on Jul. 1, 2008.

(30) Foreign Application Priority Data
Jul. 2, 2007 (CN) 200710028951.X
Jul. 18, 2007 (CN) 200710138938.X

(51) Int. Cl. G06F 15/177; G06F 21/00

(52) U.S. Cl. 726/3; 709/220

(57) ABSTRACT

A network access method is disclosed. The method includes: by an access authenticator, receiving a Discover message sent by a client, returning a response message, and obtaining first configuration information used by the client during authentication, where the Discover message is used to discover the access authenticator; authenticating the client or interacting with an authentication server (AS) to authenticate the client remotely as an agent of the client; and sending a configuration request message to a configuration server to request second configuration information used by the client during a session after the authentication succeeds. A network access system, an access authentication apparatus and a broadband access device are also disclosed. The present invention can assure the stability of authentication.

### CROSS-REFERENCE TO RELATED PATENT APPLICATIONS

This application claims benefits of the filing dates of Chinese Patent Application 200710028951.X, filed Jul. 2, 2007, Chinese Patent Application 200710138938.X, filed Jul. 18, 2007, and PCT Patent Application PCT/CN2008/071506, filed Jul. 1, 2008, commonly assigned, and which are incorporated herein by reference for all purposes.

### FIELD OF THE INVENTION

The present invention relates to the network communication field, and in particular, to a network access method, system, and apparatus.

### BACKGROUND OF THE INVENTION

The Dynamic Host Configuration Protocol (DHCP) is a mechanism for dynamically assigning IP addresses and configuration parameters. It is mainly applied in large networks and in networks where it is hard to implement configuration. A DHCP system includes a DHCP server and DHCP clients. Some systems also include a DHCP authentication server (AS). The DHCP server automatically assigns IP addresses and configuration parameters to clients, making communications between the computers in the network much easier. The DHCP server performs centralized management on all configuration information, assigns IP addresses, configures a large number of other parameters, and manages IP addresses by lease. Thus, the DHCP system has various advantages such as time division multiplex of IP addresses, and has been widely applied in networks.

In the DHCP system, the DHCP server manages all IP network settings and processes the requests of DHCP clients, whereas the DHCP clients use the IP environment information distributed by the DHCP server. FIG. 1 is a flowchart of DHCP authentication in the prior art. As shown in FIG. 1, the system includes a DHCP client, a DHCP server, and an AS. The DHCP client is a host or a device that may obtain configuration parameters (such as IP address) through DHCP. The DHCP server, which is deployed on a router, an L3 switch, or a special DHCP server, provides DHCP services and IP addresses or other network parameters for different DHCP clients. The AS authenticates the authentication information provided by DHCP clients and returns the authentication results to DHCP clients. FIG. 1 shows a combination of DHCPv4 messages and DHCP options in the prior art. Options can be customized by vendors to provide more setting information. The following describes the DHCP authentication process with reference to FIG. 1 and Table 1. In the prior art, the DHCP authentication is implemented through two DHCPv4 messages (DHCP Auth-request and DHCP-response) or one DHCP message (DHCP EAP) and two DHCP Option messages (authentication protocol Option (auth-proto) and EAP-Message Option).

TABLE 1

| DHCPv4 Message | EAP Message | Function Description |
|---|---|---|
| DHCP Discover | — | 1. This message is broadcast to request a DHCP |
| (auth-proto Option) | | server and its IP address. The source IP |
| | | address of this message is 0.0.0.0. |
| | | 2. This message indicates the authentication |
| | | mode supported by the DHCP client. |
| | | It is sent from the DHCP client to the DHCP |
| | | server. |
| DHCP Auth-response | EAP Request/ | This message carries a corresponding EAP |
| (EAP-Message | Response | message. |
| Option)/DHCP | | It is sent from the DHCP client to the DHCP |
| EAP(EAP-Message | | server. |
| Option) | | |
| DHCP Auth-request | EAP Request/ | This message carries a corresponding EAP |
| (EAP-Message Option)/ | Response | message. |
| DHCP | | It is sent from the DHCP server to the DHCP |
| EAP (EAP-Message | | client. |
| Option) | | |
| DHCP Offer | EAP | 1. This message carries configurable network |
| (EAP-Message Option) | Success/Failure | parameters such as a user's IP address. |
| | | 2. This message carries a corresponding EAP |
| | | message. |
| | | It is sent from the DHCP server to the DHCP |
| | | client. |

Step S101: When connecting to the network, the DHCP client broadcasts a DHCP Discover message to the DHCP server. The auth-proto Option in the DHCP Discover message carries the authentication mode supported by the DHCP client. The DHCP Discover message is used to request the IP address of a DHCP server. The source IP address of this message is 0.0.0.0.

Step S102: After receiving the DHCP Discover message, the DHCP server returns a DHCP Auth-request or DHCP EAP message to the DHCP client. The EAP Request message is carried in the EAP-Message Option of the DHCP Auth-request message or the DHCP EAP message.

Step S103: After receiving the DHCP Auth-request or DHCP EAP message, the DHCP client sends a DHCP Auth-response message to the DHCP server. The EAP Response message is carried in the EAP-Message Option of the DHCP Auth-response message or the DHCP EAP message.

Step S104: The DHCP server encapsulates the EAP message sent by the DHCP client in an Authentication, Authorization and Accounting (AAA) message and sends the AAA message to the AS.

Step S105: The AS sends the authentication result to the DHCP server. If the authentication succeeds, the AS sends an EAP Success message to the DHCP server through the AAA protocol.

Step S106: The DHCP server constructs a DHCP Offer message carrying the EAP Success message, and sends the DHCP Offer message to the DHCP client. The DHCP Office message carries the IP address to be assigned to the DHCP client in the your ip address (yiaddr) option.

Step S107: After receiving the DHCP Offer message, the DHCP client returns a DHCP request message to the DHCP server.

Step S108: The DHCP server returns a DHCP ACK message to the DHCP client.

In the foregoing solution, corresponding EAP messages are carried in the messages between the DHCP server and the AS during authentication, which causes changes in the processing flows between the DHCP server and the AS. Therefore, it is necessary to reconstruct the DHCP server and AS to support corresponding authentication functions, thus increasing the operation cost. In addition, in the process shown in FIG. 1, authentication may proceed only after the DHCP client is assigned a static IP address. In the process of dynamic IP address assignment, if a user does not have an IP address before the authentication, the authentication process starting from step S102 may not be performed.

### SUMMARY OF THE INVENTION

Embodiments of the present invention provide a network access method, system, and apparatus to resolve the foregoing issue in the prior art. An access authenticator is set in the access system. Different DHCP clients may configure corresponding configuration parameters through a DHCP access authenticator to implement authentication. In this way, authentication may be performed without any change to the DHCP server.

To resolve the foregoing technical issue, an embodiment of the invention provides a network access method. The method includes:

receiving, by an access authenticator, a DHCP discover message from a client, responding to the DHCP discover message with first configuration information used by the client during authentication, wherein the DHCP Discover message is used to discover the access authenticator;

authenticating, by the access authenticator, the client locally, or interacting with an AS to authenticate the client remotely as an agent of the client; and

after the authentication succeeds, sending, by the access authenticator, a configuration request message to a configuration server to request second configuration information used by the client during a session.

Accordingly, an embodiment of the present invention provides a network access system. The system includes an access authenticator and a configuration server.

The access authenticator is configured to receive a discover message from a client, return a response message, provide first configuration information used by the client during authentication, authenticate the client locally if the client is local, otherwise, interact with an AS to authenticate the client remotely as an agent of the client, and if the authentication succeeds, send a configuration request message to the configuration server to request second configuration information used by the client during a session.

The configuration server is configured to provide configuration information for the client, where the configuration information may include at least the second configuration information.

Accordingly, an embodiment of the present invention provides an access authentication apparatus. The apparatus includes:

a first processing module, configured to receive a discover message sent by a client, obtain first configuration information used by the client during authentication, and send the first configuration information to the client;

an authenticating module, configured to authenticate the client locally or interact with an AS to authenticate the client remotely as an agent of the client; and

a second processing module, configured to send a configuration request to a configuration server to request second configuration information used by the client during a session if the authentication succeeds.

Accordingly, an embodiment of the present invention also provides a broadband access device, which includes an access authentication apparatus. The access authentication apparatus includes:

a first processing module, configured to receive a discover message sent by a client, obtain first configuration information used by the client during authentication, and send the first configuration information to the client;

an authenticating module, configured to authenticate the client locally or interact with an AS to authenticate the client remotely as an agent of the client; and

a second processing module, configured to send a configuration request to a configuration server to request second configuration information used by the client during a session if the authentication succeeds.

In embodiments of the present invention, an access authenticator is set in the network to authenticate a client as an authentication agent of the client. In this way, a DHCP client may be authenticated without any special change to the DHCP server, but a first network address is provided for the client before the authentication. Thus, the stability of authentication is improved and the efficiency and success rate of authentication are increased.

### BRIEF DESCRIPTION OF THE DRAWINGS

FIG. 1 is a flowchart of a DHCP authentication method in the prior art;

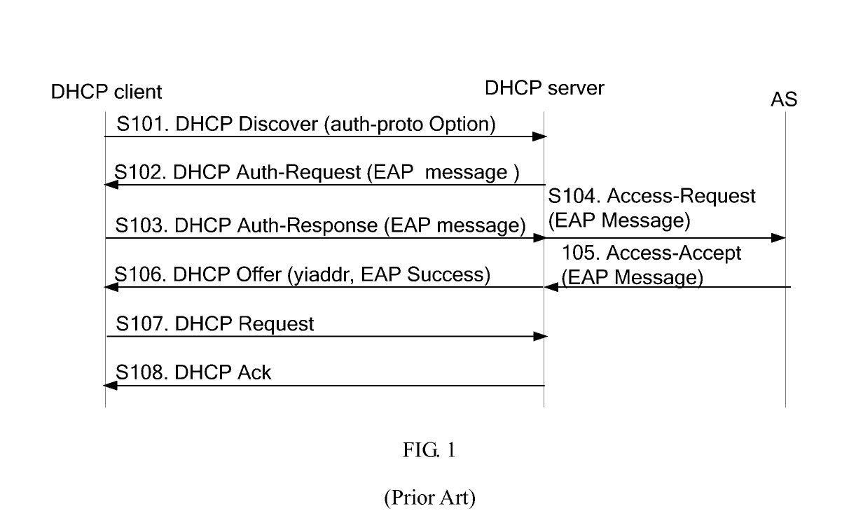

FIG. 2 shows a structure of a DHCP authentication system according to an embodiment of the present invention;

FIG. 3 is a schematic diagram illustrating an IP session during which packets or data streams are filtered in encrypted mode after DHCP authentication according to an embodiment of the present invention;

FIG. 4 is a schematic diagram illustrating an IP session during which packets or data streams are filtered in non-encrypted mode after DHCP authentication according to an embodiment of the present invention;

FIG. 5 is a flowchart of initial successful DHCP authentication through DHCPv4 messages in Table 2 according to an embodiment of the present invention;

FIG. 6 is a flowchart of initial unsuccessful authentication through DHCPv4 messages in Table 2 according to an embodiment of the present invention;

FIG. 7 is a flowchart of initial successful authentication through DHCPv6 messages in Table 3 according to an embodiment of the present invention;

FIG. 8 is a flowchart of initial unsuccessful authentication through DHCPv6 messages in Table 3 according to an embodiment of the present invention;

FIG. 9 is a simplified flowchart of initial successful authentication through DHCPv4 messages in Table 2 according to an embodiment of the present invention;

FIG. 10 is a flowchart of successful re-authentication through DHCPv4 messages in Table 2 according to an embodiment of the present invention;

FIG. 11 is a flowchart of initial successful authentication through DHCPv4 messages in Table 4 according to an embodiment of the present invention;

FIG. 12 is a flowchart of initial unsuccessful authentication through DHCPv4 messages in Table 5 according to an embodiment of the present invention;

FIG. 13 is a simplified flowchart of initial successful authentication through DHCPv4 messages in Table 4 according to an embodiment of the present invention;

FIG. 14 is a flowchart of successful re-authentication triggered by a DHCP client through DHCPv4 messages in Table 4 according to an embodiment of the present invention;

FIG. 15 is a flowchart of successful re-authentication triggered by a DHCP authenticator through DHCPv4 messages in Table 4 according to an embodiment of the present invention;

FIG. 16 is a flowchart of initial successful authentication through DHCPv4 messages in Table 5 according to an embodiment of the present invention;

FIG. 17 is another flowchart of initial successful authentication through DHCPv4 messages in Table 5 according to an embodiment of the present invention;

FIG. 18 is a flowchart of initial unsuccessful authentication through DHCPv4 messages in Table 5 according to an embodiment of the present invention;

FIG. 19 is another flowchart of initial unsuccessful authentication through DHCPv4 messages in Table 5 according to an embodiment of the present invention;

FIG. 20 is a flowchart of filtering packets or data streams in encrypted mode after successful DHCP authentication according to an embodiment of the present invention; and

FIG. 21 is a flowchart of filtering packets or data streams in non-encrypted mode after successful DHCP authentication according to an embodiment of the present invention.

### DETAILED DESCRIPTION OF THE INVENTION

Embodiments of the present invention provide a network access method, system, and apparatus. DHCP authenticators are set in the authentication system. During authentication, different DHCP clients can find corresponding DHCP authenticators, and DHCP authenticators act as agents to authenticate the DHCP clients. Therefore, it is unnecessary to reconstruct the DHCP server, thus reducing the operation cost.

Embodiments of the present invention are hereinafter described in detail with reference to accompanying drawings.

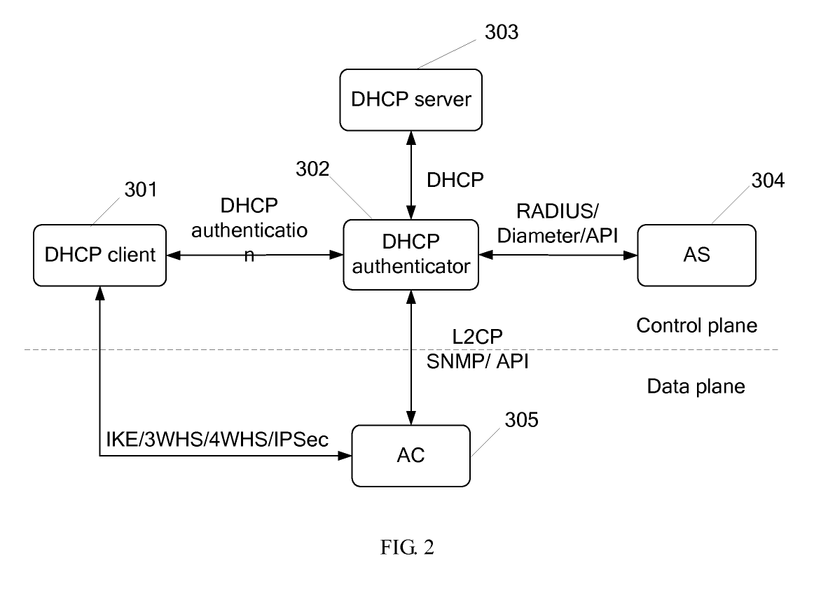

FIG. 2 shows a structure of a DHCP authentication system that separates authentication from control. The system includes multiple DHCP clients 301, a DHCP authenticator 302, an AS 304, a DHCP server 303, and an access controller (AC) 305. The AC 305 is located in the data plane, and other devices are located in the control plane.

A DHCP client 301 requests DHCP authentication. The DHCP client is allowed to access the network only after obtaining the DHCP authentication protocol. The DHCP client 301 is associated with the identity authentication information within the DHCP authentication protocol scope. The DHCP client 301 may be a terminal that connects to the network, such as a laptop, a personal digital assistant (PDA), a mobile phone, a personal computer, or a router. The DHCP client 301 needs to be authenticated by a DHCP authenticator 302 in corresponding mode.

A DHCP authenticator 302 is an access authenticator. The number of DHCP authenticators 302 may be set according to network requirements; that is, multiple DHCP authenticators 302 may be set. During DHCP authentication, a DHCP authenticator interacts with the supported DHCP client 301 through the DHCP authentication protocol. After receiving a DHCP Discover message from the DHCP client 301, the DHCP authenticator exchanges information with the DHCP server 303 and obtains the first configuration information, namely, a temporary IP address, for the DHCP client from the DHCP server 303. The DHCP client uses the temporary IP address to exchange information with the AS 304, and the AS 304 authenticates the DHCP client. The DHCP authenticator 302, acting as the authentication agent of the DHCP client 301, interacts with the AS 304 through the AAA protocol, and authenticates and authorizes the DHCP client 301. In addition, the DHCP authenticator may record the first configuration information returned by the DHCP server 303, replace the temporary IP address in the first configuration information with an IP address used by the client in the local network, and send the configuration information to the DHCP client 301. The DHCP authenticator 302 may update the access control status of the DHCP client 301 by adding or canceling the access right. The DHCP authenticator 302 also acts as a relay in the DHCP authentication process. The DHCP authenticator 302 may be a broadband remote access server (BRAS) on the IP edge node, or a broadband network gateway (BNG) in the network, or any other access device. The DHCP authenticator 302 may be integrated with the AS 304.

The DHCP authenticator 302 includes:

a first processing module, configured to: receive the DHCP Discover message sent by the DHCP client 301, return a response message, obtain the first configuration information (namely, a temporary IP address) for the DHCP client 301 to use during authentication, and send the information to the DHCP client 301;

an authenticating module, configured to authenticate the client locally or interact with the AS to authenticate the client remotely as an agent of the client;

a second processing module, configured to send a configuration request to the configuration server (namely, the DHCP server 303) to request the second configuration information used by the client during a session; and

a re-authenticating module, configured to re-authenticate the DHCP client 301 during the session.

The DHCP server 303 provides configuration services such as dynamic host configuration services for the DHCP client 301 through the DHCP protocol according to the request sent by the DHCP client 301, and provides the second configuration information (namely, an IP address for the DHCP client 301 to use in an session) after the authentication succeeds. The AS 304 checks the authentication information provided by the DHCP client 301 and returns the check result and authorization parameters to the DHCP client 301. The AS 304 may be located in the same node as the DHCP authenticator 302 and transfer data through an application programming interface (API). The AS 304 may also be a special AS in the network. If the DHCP authenticator 302 and the AS 304 are not located in the same network node, another protocol such as the RADIUS protocol or the Diameter protocol (the upgrade version of the RADIUS protocol) may be used to carry AAA messages to implement data interactions during the authentication.

The AC 305 is configured to: monitor the packets or data streams transmitted from or to the DHCP client 301, and filter the packets or data streams in non-encrypted or encrypted mode according to the access control policy obtained from the DHCP authenticator 302. The AC 305 may filter data streams at the link layer or at the network layer or communication layer above the network layer. Generally, the AC 305 is located on a link between the DHCP client 301 and the DHCP authenticator 302. If the network layer lacks security assurance, the encrypted filter mode should be adopted, and a security association (SA) should be established between the DHCP client 301 and the AC 305 through the Internet Key Exchange (IKE) protocol, or 802.11i 4-Way Handshake (4WHS) protocol, or 802.16 3-Way Handshake (3WHS) protocol. After the SA is established, a link-layer or network-layer encryption protocol may be used to protect data streams. The encryption protocol may be the IP Security Protocol (IPSec), or 802.11i link-layer encryption protocol, or 802.16 link-layer encryption protocol. If the DHCP authenticator 302 and the AC 305 are located in the same node, they may communicate with each other directly through the API. Otherwise, the Layer 2 Control Protocol (L2CP) or the Simple Network Management Protocol (SNMP) may be used. The AC 305 may include a detecting unit and a data filtering unit. The detecting unit is configured to monitor the packets or data streams transmitted by the client. The data filtering unit is configured to filter the packets or data streams in encrypted or non-encrypted mode according to the control policy provided by the DHCP authenticator 302. In this case, the DHCP authenticator 302 is connected to the DHCP server 303 and the AS 304, and provides related information such as control policies for the AC 305. This mode supports more flexible information acquisition and update. Certainly, the functions of monitoring and filtering the data or data streams transmitted by or to the DHCP client 301 may be implemented by other network access devices.

Moreover, during an IP session, the DHCP client 301 determines the IP session duration by lease, and the DHCP server 303 permits the DHCP client 301 to use a specific IP address within the specified period of time. Either the DHCP server 303 or the DHCP client 301 can terminate the lease at any time during the IP session. When over 50% of the lease of the DHCP client expires, the lease may be updated. An IP address may be reassigned to the DHCP client 301 when the lease is updated.

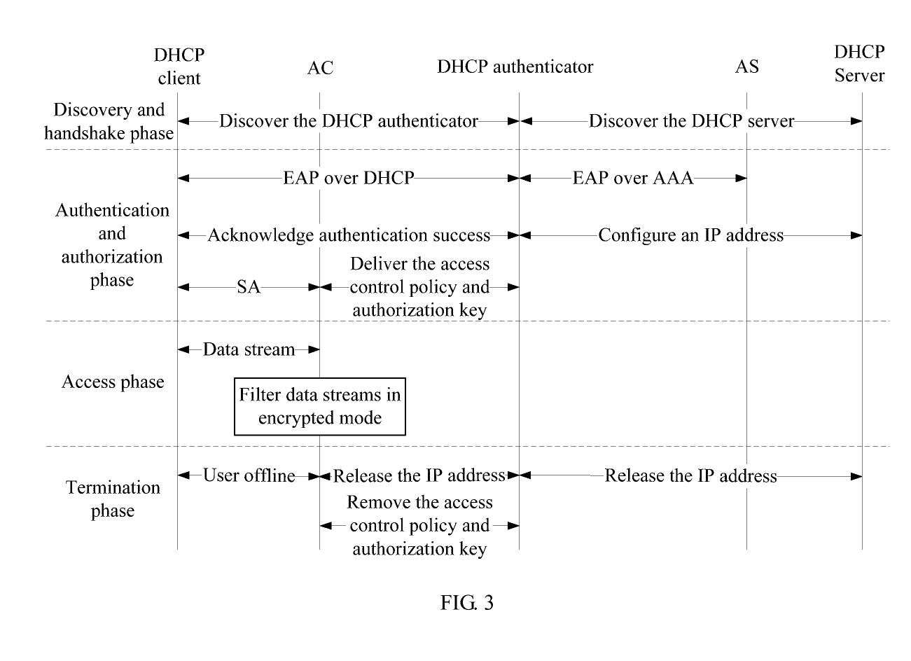

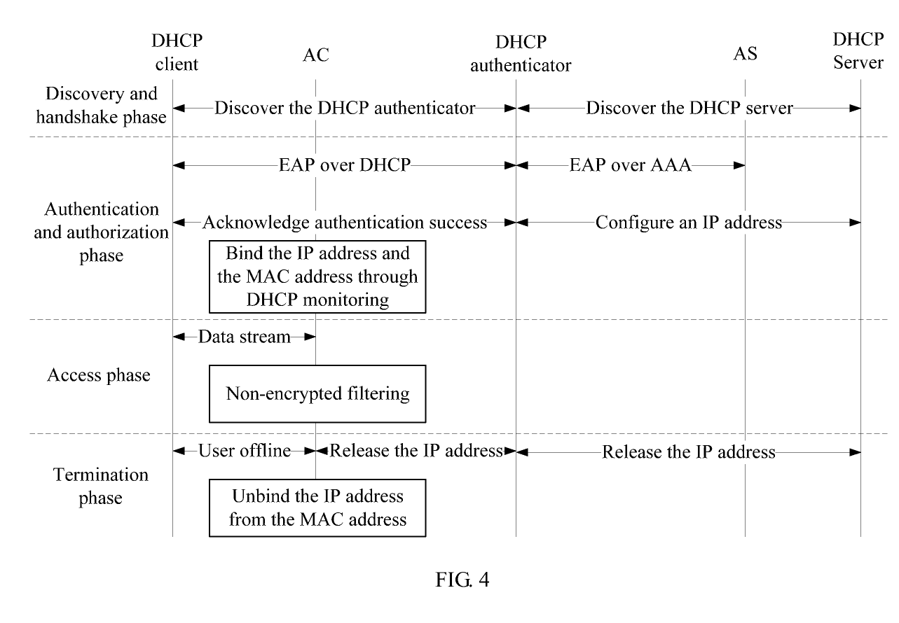

FIG. 3 and FIG. 4 show a lifecycle of an IP session during DHCP authentication. FIG. 3 shows a lifecycle of an IP session during which data streams are filtered in encrypted mode in the DHCP authentication process. FIG. 4 shows a lifecycle of an IP session during which data streams are filtered in non-encrypted mode in the DHCP authentication process. An IP session corresponding to a DHCP authentication process covers five phases:

(1) Discovery and handshake phase: A new IP session is initiated. The DHCP client may find a DHCP authenticator by broadcasting a request to specific DHCP authenticators. The DHCP authenticator starts a new session by sending a response.

(2) Authentication and authorization phase: After the discovery and handshake phase, authentication messages are transmitted between the DHCP authenticator and the DHCP client. The EAP carried in the DHCP messages carries various EAP authentication methods and is used to authenticate the DHCP client. In this phase, EAP authentication may be performed twice: one for the network access provider (NAP) and the other one for the Internet service provider (ISP). The DHCP authenticator transmits the authentication and authorization result to the DHCP client at the end of this phase.

(3) Access phase: After the authentication and authorization succeed, the DHCP client is allowed to access the network. The IP data transmitted and received by the client may be checked by the AC. In addition, the DHCP client and the DHCP authenticator may send IP session test data to check the time to live (TTL) of the IP session of the peer at any time in this phase.

(4) Re-authentication phase: During an IP session, EAP authentication is performed again to shift from the access phase to the re-authentication phase. After the re-authentication succeeds, the process goes back to the access phase, and the TTL of the current IP session is prolonged. Otherwise, the IP session is deleted. Re-authentication may be initiated by the DHCP authenticator or the DHCP client, or triggered by the DHCP authenticator.

(5) Termination phase: The DHCP client or the DHCP authenticator may send a Disconnect message, for example, a DHCP Release message, to terminate an IP session at any time, thus terminating the access service. If a connection is disconnected without a Disconnect message, the IP session may expire, or the IP session status detection may fail.

The whole DHCP authentication process is hereinafter described in detail with reference to the TTL of an IP session in FIG. 3 and FIG. 4. Due to selection of different network IP addresses, DHCPv4 and DHCPv6 are selected for IPv4 and IPv6 respectively. Table 2 describes the functions implemented by different combinations of DHCPv4 messages and DHCP options.

TABLE 2

| DHCPv4 Message | EAP Message | Function Description |
|---|---|---|
| DHCP Discover | — | 1. This message is broadcast to request the IP |
| (auth-proto Option) | | addresses of the DHCP authenticator and DHCP |
| | | server. The source IP address of this message is |
| | | 0.0.0.0. |
| | | 2. This message indicates the authentication mode |
| | | supported by the DHCP client. |
| | | It is sent from the DHCP client to the DHCP |
| | | authenticator. |
| DHCP Offer | — | 1. This message is an authentication response |
| (auth-proto Option) | | returned by each DHCP authenticator, and |
| | | indicates the authentication mode supported by |
| | | each DHCP authenticator. |
| | | 2. This message provides an unleased IP address |
| | | and other DHCP configuration information (such |
| | | as subnet mask and default gateway) for the |
| | | DHCP client. |
| | | It is sent from the DHCP authenticator to the DHCP |
| | | client. |
| DHCP Request | — | 1. This message carries the authentication mode |
| (auth-proto Option) | | supported and the IP address provided by the |
| | | DHCP authenticator, indicating that the DHCP |
| | | client has accepted the provided IP address and |
| | | DHCP authenticator. |
| | | It is sent from the DHCP client to the DHCP |
| | | authenticator. |
| DHCP Offer | EAP | 1. This message is an authentication response |
| (auth-proto Option, | Request/Identity | returned by each DHCP authenticator, and |
| EAP-Message | | indicates the authentication mode supported by |
| Option) | | each DHCP authenticator. The auth-proto Option |
| | | is optional. |
| | | 2. This message provides an unleased IP address |
| | | and other DHCP configuration information (such |
| | | as subnet mask and default gateway) for the |
| | | DHCP client. |
| | | 3. This message carries a corresponding EAP |
| | | message. |
| | | It is sent from the DHCP authenticator to the DHCP |
| | | client. |
| DHCP Request | EAP Request/ | 1. This message carries the IP address provided by |
| (EAP-Message | Response | the DHCP authenticator, indicating that the |
| Option) | | DHCP client has accepted the provided IP |
| | | address and DHCP authenticator. |
| | | 2. This message carries a corresponding EAP |
| | | message. |
| | | It is sent from the DHCP client to the DHCP |
| | | authenticator. |
| DHCP Inform | EAP Request/ | 1. This message carries the corresponding EAP |
| (EAP-Message | Response | message. It is used when the DHCP client has |
| Option) | | been configured with an IP address statically. |
| | | 2. It is sent from the DHCP client to the DHCP |
| | | authenticator. |
| DHCP ACK | EAP Request/ | 1. This message carries configurable network |
| (EAP-Message | Response/ | parameters such as a user's IP address (yiaddr). |
| Option) | Success | 2. This message carries a corresponding EAP |
| | | message. |
| | | It is sent from the DHCP authenticator to the DHCP |
| | | client. |
| DHCP NACK | EAP Failure | This message carries a corresponding EAP message. |
| (EAP-Message | | It is sent from the DHCP authenticator to the DHCP |
| Option) | | client. |
| DHCP Release | — | This message indicates that a user is offline, and that |
| | | the corresponding session and IP address should be |
| | | released. |
| | | It is sent from the DHCP client to the DHCP |
| | | authenticator. |

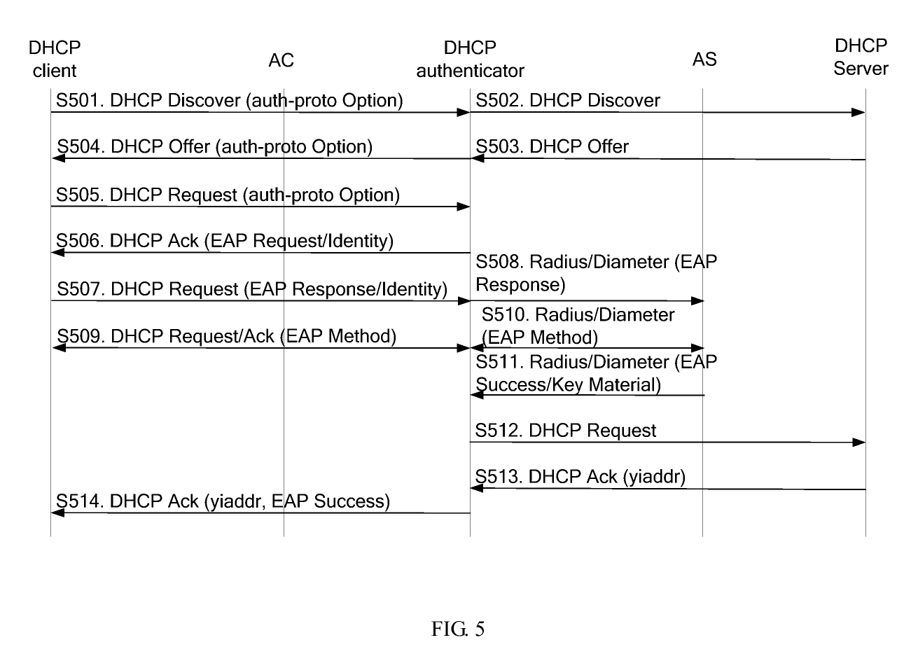

FIG. 5 is a first flowchart of initial successful DHCP authentication. The process includes the following steps:

Step S501: When connecting to the network, the DHCP client sends a DHCP Discover message to the network. This message indicates the DHCP authenticator and DHCP server involved in authentication and authorization. The auth-proto Option indicates the authentication mode supported by the DHCP client.

If the AC and the DHCP authenticator belong to different physical layers, the AC forwards the DHCP Discover message to the corresponding DHCP authenticator.

Step S502: After receiving the DHCP Discover message, the DHCP authenticator forwards the message to the DHCP server.

Step S503: The DHCP server checks the parameters in the DHCP Discover message and returns a DHCP Offer message to provide an unleased IP address and other DHCP configuration information (such as subnet mask and default gateway) for the DHCP client.

Step S504: After receiving the DHCP Offer message, the DHCP authenticator adds the authentication mode supported by the DHCP authenticator to the auth-proto Option, records the unleased IP address provided by the DHCP server for the DHCP client, replaces the unleased IP address with an IP address used by the DHCP client in the local network, and then sends the DHCP Offer message to the DHCP client.

Step S505: After receiving the DHCP Offer message, the DHCP client has a temporary IP address and responds with a DHCP Request message to the DHCP authenticator. The DHCP Request message indicates that the DHCP client selects the DHCP authenticator and accepts the IP address provided by the DHCP authenticator. The selected DHCP authenticator supports the corresponding authentication mode.

Step S506: After receiving the DHCP Request message, the DHCP authenticator sends an EAP-Request/Identity message to the DHCP client and delivers a false lease that is for the DHCP client only. The EAP-Request/Identity message is carried in the DHCP ACK message. The false lease enables the DHCP client to respond to the EAP message quickly and reserves enough time for the DHCP authenticator to return an EAP authentication message to the DHCP client.

It should be noted that during authentication, the DHCP authenticator, upon receiving a DHCP Request message, delivers a false lease for authentication of the DHCP client through the EAP message carried in the DHCP ACK message. After receiving the DHCP ACK message, the DHCP client resets the timers T1 and T2 according to the false lease. When the T1 or T2 expires, the DHCP Request message is retriggered to update the false lease so as to carry the time of sending the EAP message.

Step S507: After receiving the DHCP ACK message that carries the EAP-Request/Identity message, the DHCP client returns the received EAP-Request/Identity message to the DHCP authenticator through a DHCP Request message according to the T1 and T2 timers set by the false lease when the T1 timer expires. If the message cannot be returned before the T1 timer expires, it must be returned before the T2 timer expires.

Step S508: The DHCP authenticator sends an EAP Response message to the AS through the AAA protocol.

Step S509: The DHCP client and the DHCP authenticator interact with each other through the EAP messages carried in the DHCP Request and DHCP ACK messages.

Step S510: The DHCP authenticator and the AS interact with each other through the EAP messages carried in the AAA messages.

Step S509 and step S510: The EAP method negotiation and exchange are performed synchronously to check and verify the identity of the DHCP client. This process lasts until the EAP authentication ends.

Step S511: The AS notifies the DHCP authenticator of the authentication success.

It should be noted that in steps S509, S510, and S511, if the DHCP authenticator and the AS are located in the same network node, they may exchange data through the API; if the DHCP authenticator and the AS are located in different network nodes, they exchange authentication data through AAA messages by using another protocol such as the RADIUS protocol or the Diameter protocol (the upgrade version of the RADIUS protocol).

Step S512: The DHCP authenticator constructs a DHCP Request message according to the recorded unleased IP address that is provided by the DHCP server for the DHCP client, and sends the message to the DHCP server.

Step S513: The DHCP server assigns a global IP address and a real lease to the DHCP client according to the parameters in the DHCP Request message constructed by the DHCP authenticator, and returns a DHCP ACK message to the DHCP authenticator. The DHCP ACK message carries the EAP Success message and the IP address (yiaddr) assigned to the user.

Step S514: After receiving the EAP Success message, the DHCP authenticator re-encapsulates the EAP Success message into a DHCP ACK message, and sends the message to the DHCP client. The DHCP ACK message carries the global IP address and the real lease assigned to the DHCP client.

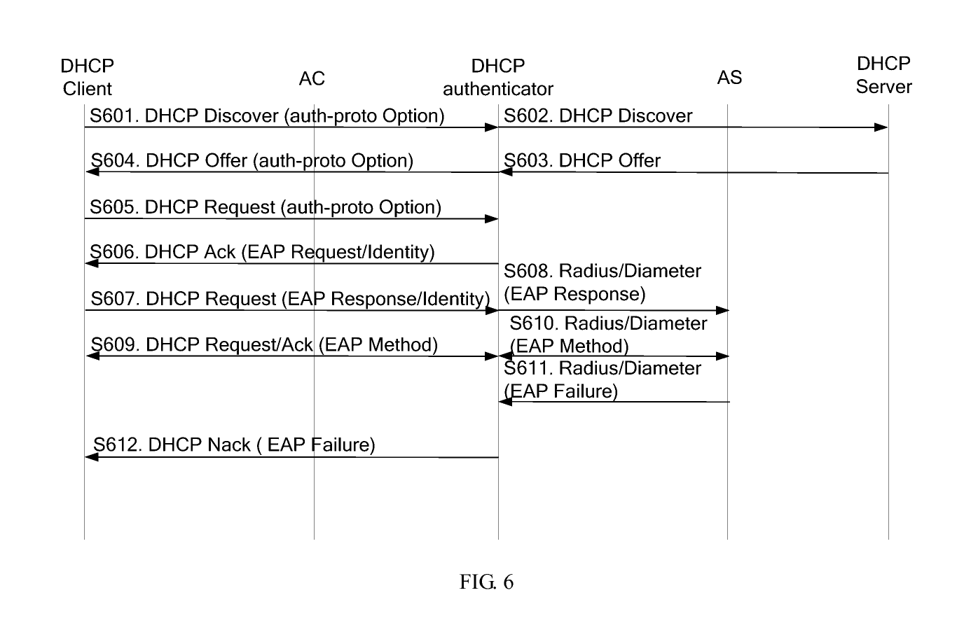

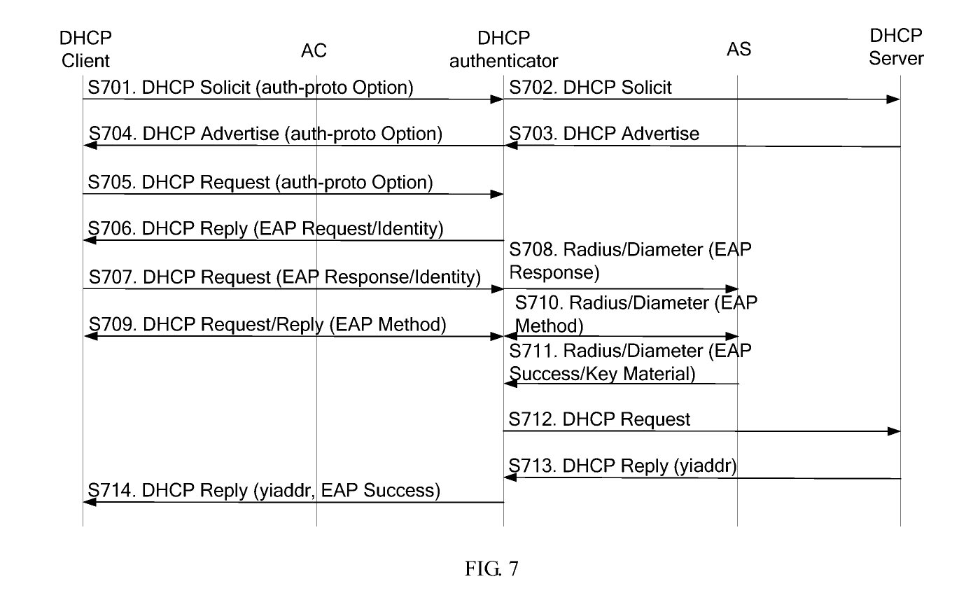

FIG. 5 is a flowchart of initial successful DHCPv4 authentication. The initial authentication may fail. The authentication process in which initial authentication fails is hereinafter described with reference to FIG. 6, Table 2, and FIG. 5. Steps S701 to S710 in FIG. 7 are the same as steps S501 to S510 in FIG. 5. The process after the AS authentication fails includes the following steps:

Step S611: After the authentication fails, the AS sends an AAA message carrying the EAP Failure message to the DHCP authenticator.

Step S612: After receiving the EAP Failure message, the DHCP authenticator sends a DHCP NACK message carrying the EAP Failure message to the DHCP client.

The DHCPv4 authentication process is described above. The following describes the DHCPv6 authentication process. Table 3 describes the functions implemented by different combinations of DHCPv6 messages and DHCP options.

TABLE 3

| DHCPv6 Message | EAP Message | Function Description |
|---|---|---|
| DHCP Solicit | — | 1. This message is broadcast to request the IP |
| (auth-proto Option) | | addresses of the DHCP authenticator and |
| | | DHCP server. The source IP address of this |
| | | message is 0.0.0.0. |
| | | 2. This message indicates the authentication mode |
| | | supported by the DHCP client. |
| | | It is sent from the DHCP client to the DHCP |
| | | authenticator. |
| DHCP Advertise | — | 1. This message is an authentication response |
| (auth-proto Option) | | returned by each DHCP authenticator, and |
| | | indicates the authentication mode supported by |
| | | each DHCP authenticator. |
| | | 2. This message provides an unleased IP address |
| | | and other DHCP configuration information |
| | | (such as subnet mask and default gateway) for |
| | | the DHCP client. |
| | | It is sent from the DHCP authenticator to the DHCP |
| | | client. |
| DHCP Request | — | 1. This message carries the authentication mode |
| (auth-proto Option) | | supported and the IP address provided by the |
| | | DHCP authenticator, indicating that the DHCP |
| | | client has accepted the provided IP address and |
| | | DHCP authenticator. |
| | | It is sent from the DHCP client to the DHCP |
| | | authenticator. |
| DHCP Advertise | EAP | 1. This message is an authentication response |
| (auth-proto Option, | Request/Identity | returned by each DHCP authenticator, and |
| EAP-Message | | indicates the authentication mode supported by |
| Option) | | each DHCP authenticator. The auth-proto |
| | | Option is optional. |
| | | 2. This message provides an unleased IP address |
| | | and other DHCP configuration (such as subnet |
| | | mask and default gateway) for the DHCP |
| | | client. |
| | | 3. This message carries a corresponding EAP |
| | | message. |
| | | It is sent from the DHCP authenticator to the DHCP |
| | | client. |
| DHCP Request | EAP Request/ | 1. This message carries the IP address provided by |
| (EAP-Message | Response | the DHCP authenticator, indicating that the |
| Option) | | DHCP client has accepted the provided IP |
| | | address and DHCP authenticator. |
| | | 2. This message carries a corresponding EAP |
| | | message. |
| | | It is sent from the DHCP client to the DHCP |
| | | authenticator. |
| DHCP Reply | EAP Request/ | 1. This message carries configurable network |
| (EAP-Message | Response/ | parameters such as a user's IP address. |
| Option) | Success/Failure | 2. This message carries a corresponding EAP |
| | | message. |
| | | It is sent from the DHCP authenticator to the DHCP |
| | | client. |
| DHCP Release | — | This message indicates that a user is offline, and |
| | | that the corresponding session and IP address |
| | | should be released. |
| | | It is sent from the DHCP client to the DHCP |
| | | authenticator. |

The DHCPv6 authentication process is described with reference to Table 3 and FIG. 7.

Step S701: When connecting to the network, the DHCP client sends a DHCP Solicit message to the network. This message indicates the DHCP authenticator and DHCP server involved in authentication and authorization. The auth-proto Option indicates the authentication mode supported by the DHCP client.

If the AC and the DHCP authenticator belong to different physical layers, the AC forwards the DHCP Solicit message to the corresponding DHCP authenticator.

Step S702: After receiving the DHCP Solicit message, the DHCP authenticator forwards the message to the DHCP server.

Step S703: The DHCP server checks the parameters in the DHCP Solicit message and returns a DHCP Advertise message to provide an unleased IP address and other DHCP configuration information (such as subnet mask and default gateway) for the DHCP client.

Step S704: After receiving the DHCP Advertise message, the DHCP authenticator adds the authentication mode supported by the DHCP authenticator in the auth-proto Option, records the unleased IP address provided by the DHCP server for the DHCP client, replaces the unleased IP address with an IP address used by the client in the local network, and then sends the DHCP Advertise message to the DHCP client.

Step S705: After receiving the DHCP Advertise message, the DHCP client obtains a temporary IP address from the message. The DHCP client responds with a DHCP Request message. The DHCP Request message indicates that the DHCP client selects the DHCP authenticator and accepts the IP address provided by the DHCP authenticator. The selected DHCP authenticator supports the corresponding authentication mode.

Step S706: After receiving the DHCP Request message, the DHCP authenticator sends an EAP-Request/Identity message to the DHCP client and delivers a false lease that is for the DHCP client only. The EAP-Request/Identity message is carried in the DHCP Reply message. The false lease enables the DHCP client to respond to the EAP message quickly and reserves enough time for the DHCP authenticator to return an EAP authentication message to the DHCP client.

Step S707: After receiving the DHCP Reply message carrying the EAP-Request/Identity message, the DHCP client returns the EAP-Response/Identity message to the DHCP authenticator, indicating that the EAP-Request/Identity message is received. The EAP-Request/Identity message is carried in a DHCP Request message.

Step S708: The DHCP authenticator sends an EAP Response message to the AS through the AAA protocol.

Step S709: The DHCP client and the DHCP authenticator exchange EAP messages. The EAP messages are carried in the DHCP Request/Reply messages.

Step S710: The DHCP authenticator and the AS exchange EAP messages. The EAP messages are carried in the AAA messages.

In step S709 and step S710, the EAP method negotiation and exchange are performed synchronously to check and verify the identity of the DHCP client. This process lasts until the EAP authentication ends.

Step S711: The AS notifies the DHCP authenticator of the authentication success.

Step S712: The DHCP authenticator constructs a DHCP Request message according to the recorded unleased IP address that is provided by the DHCP server for the DHCP client, and sends the message to the DHCP server.

Step S713: The DHCP server assigns a global IP address and a real lease to the DHCP client according to the parameters in the DHCP Request message constructed by the DHCP authenticator, and returns a DHCP Reply message to the DHCP authenticator. The DHCP Reply message carries the EAP Success message.

Step S714: After receiving the EAP Success message, the DHCP authenticator re-encapsulates the EAP Success message into a DHCP Reply message, and sends the message to the DHCP client. The DHCP Reply message carries the global IP address and the real lease assigned to the DHCP client.

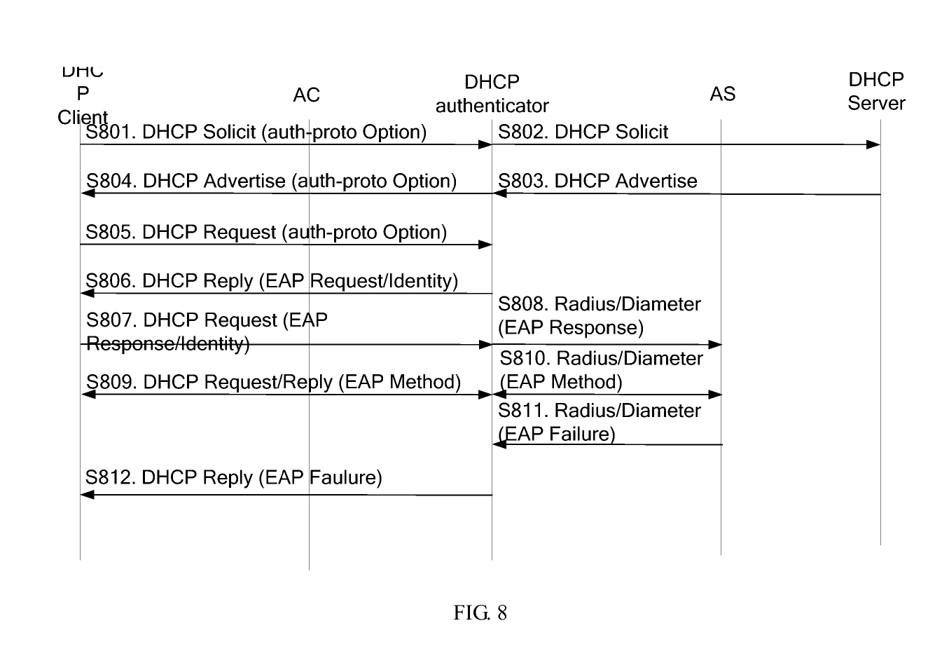

FIG. 7 is a flowchart of initial successful DHCPv6 authentication. The initial authentication may fail. The authentication process in which initial authentication fails is hereinafter described with reference to FIG. 8, Table 3, and FIG. 7. Steps S801 to S810 in FIG. 8 are the same as steps S701 to S710 in FIG. 7. The following describes the steps after the AS authentication fails:

Step S8011: After the authentication fails, the AS sends an AAA message carrying the EAP Failure message to the DHCP authenticator.

Step S8012: After receiving the EAP Failure message, the DHCP authenticator sends a DHCP Reply message carrying the EAP Failure message to the DHCP client.

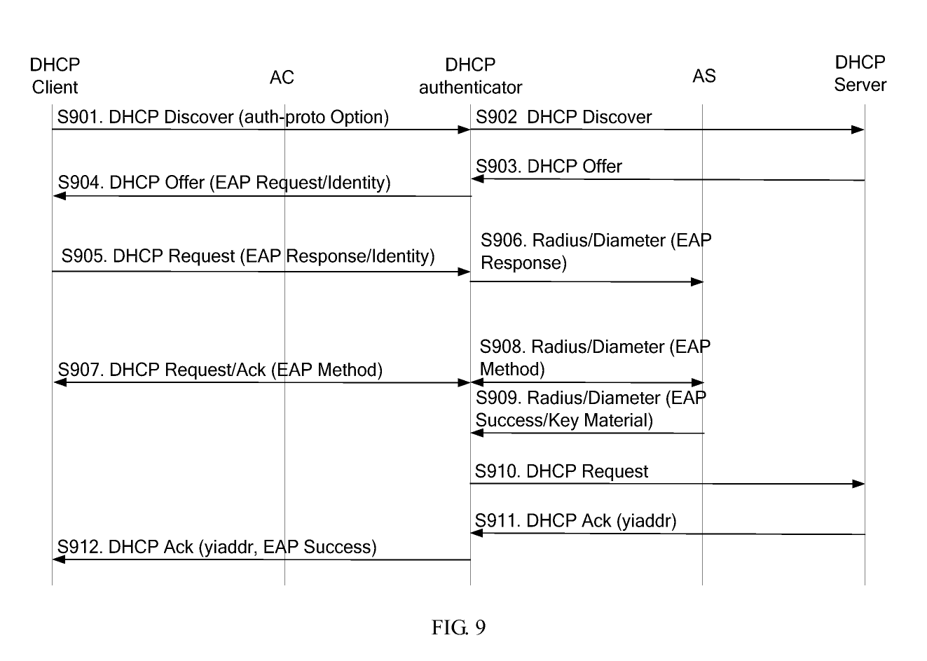

According to an embodiment of the present invention, the initial authentication process may be simplified according to actual requirements. FIG. 9 shows the simplified initial authentication process in the discovery phase according to FIG. 5 and Table 2. The steps S901 to S903 are the same as steps S501 to S503 in FIG. 5. In step S904, after receiving the DHCP Offer message, the DHCP authenticator directly adds the EAP-Request/Identity message in a DHCP Offer message, records the unleased IP address provided by the DHCP server for the DHCP client, replaces the unleased IP address with an IP address used by the DHCP client in the local network, and sends the DHCP Offer message to the DHCP client. Then the process proceeds to the steps S905 to S912, which are the same as the steps S507 to S514 in FIG. 5.

As shown in FIG. 6, the process directly goes to step S608 to start authentication after the DHCP authenticator sends a DHCP Offer message carrying the EAP-Request/Identity message to the DHCP client in step S604. Similarly, the process directly goes to step S708 or S808 to start authentication after the DHCP authenticator sends a DHCP Advertise message carrying the EAP-Request/Identity message to the DHCP client in step S704 or S804.

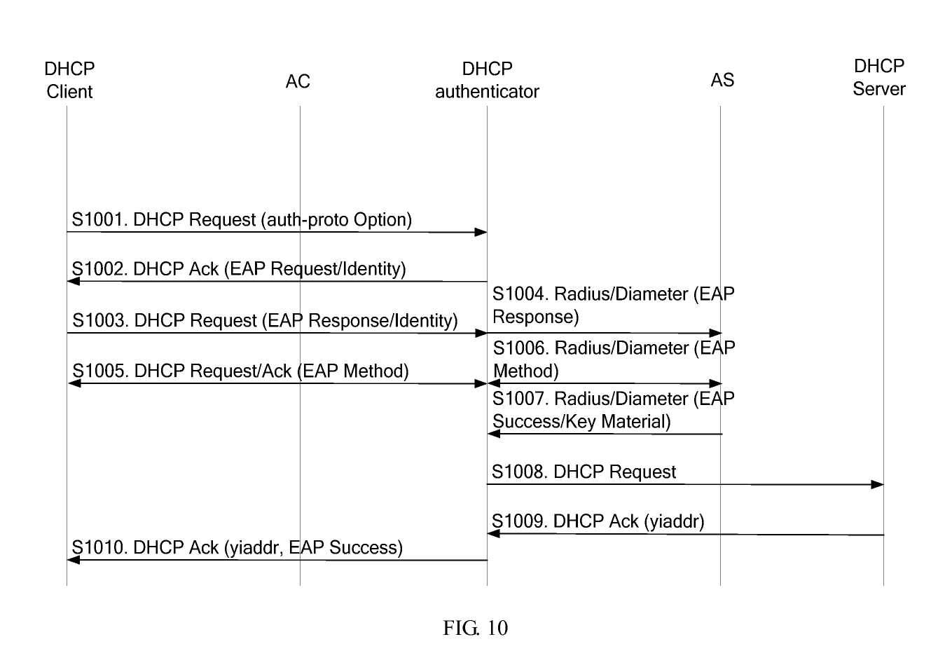

After the DHCP client passes the authentication, upon expiry of the IP session lease, re-authentication needs to be performed to reassign an IP address to the DHCP client so as to prolong the IP session time. The re-authentication process omits the discovery phase and directly proceeds to the handshake phase. The re-authentication process is hereinafter described with reference to Table 2 and FIG. 10. In step S1001, when the lease expires, the DHCP client directly sends a DHCP Request message within the preset time. The DHCP Request message carries the authentication mode supported and the IP address provided by the DHCP authenticator, indicating that the DHCP selects the DHCP authenticator and accepts the IP address provided by the DHCP authenticator. The selected DHCP authenticator supports the corresponding authentication mode. In step S1002, after receiving the DHCP Request message, the authenticator performs a step same as step S508 in FIG. 5. The steps S1002 to S1010 are the same as steps S506 to S514. Similarly, re-authentication may fail. After the re-authentication fails, the DHCP authenticator may re-authenticate the DHCP client according to the configuration parameters of the DHCP client until the re-authentication succeeds. FIG. 10 shows a re-authentication method. Details are omitted here.

The DHCPv6 messages listed in Table 3 for re-authentication after the DHCP authentication succeeds are similar to the DHCPv4 messages for re-authentication, but the DHCP messages used for authentication are different.

The foregoing method implements different functions by different combinations of original DHCPv4 or DHCPv6 messages and two new DHCP options. Also, an embodiment of the present invention implements DHCP authentication through combinations of new DHCP messages and new DHCP options. Table 4 describes the functions implemented by different combinations of DHCPv4 messages and DHCP options. Table 5 describes the functions implemented by different combinations of DHCPv6 messages and DHCP options.

TABLE 4

| DHCPv4 Message | EAP Message | Function Description |
|---|---|---|
| DHCP Discover | — | 1. This message is broadcast to request the IP |
| (auth-proto Option) | | addresses of the DHCP authenticator and |
| | | DHCP server. The source IP address of this |
| | | message is 0.0.0.0. |
| | | 2. This message indicates the authentication |
| | | mode supported by the DHCP client. |
| | | It is sent from the DHCP client to the DHCP |
| | | authenticator. |
| DHCP Offer (auth-proto | — | 1. This message is an authentication response |
| Option) | | returned by each DHCP authenticator, and |
| | | indicates the authentication mode supported |
| | | by each DHCP authenticator. |
| | | 2. This message provides an unleased IP |
| | | address and other DHCP configuration |
| | | information (such as subnet mask and |
| | | default gateway) for the DHCP client. |
| | | It is sent from the DHCP authenticator to the |
| | | DHCP client. |
| DHCP Request | — | 1. This message carries the authentication |
| (auth-proto Option) | | mode supported and the IP address |
| | | provided by the DHCP authenticator, |
| | | indicating that the DHCP client has |
| | | accepted the provided IP address and |
| | | DHCP authenticator. |
| | | It is sent from the DHCP client to the DHCP |
| | | authenticator. |
| DHCP Offer (auth-proto | EAP | 1. This message is an authentication response |
| Option, EAP-Message | Request/Identity | returned by each DHCP authenticator, and |
| Option) | | indicates the authentication mode supported |
| | | by each DHCP authenticator. The |
| | | auth-proto Option is optional. |
| | | 2. This message provides an unleased IP |
| | | address and other DHCP configuration |
| | | information (such as subnet mask and |
| | | default gateway) for the DHCP client. |
| | | 3. This message carries a corresponding EAP |
| | | message. |
| | | It is sent from the DHCP authenticator to the |
| | | DHCP client. |
| DHCP Auth-response | EAP Request/ | This message carries a corresponding EAP |
| (EAP-Message | Response | message. |
| Option)/DHCP EAP | | It is sent from the DHCP client to the DHCP |
| (EAP-Message Option) | | authenticator. |
| DHCP Auth-request | EAP Request/ | This message carries a corresponding EAP |
| (EAP-Message Option)/ | Response | message. |
| DHCP EAP | | It is sent from the DHCP authenticator to the |
| (EAP-Message Option) | | DHCP client. |
| DHCP ACK | EAP Success | 1. This message carries configurable network |
| (EAP-Message Option) | | parameters such as a user's IP address. |
| | | 2. This message carries a corresponding EAP |
| | | message. |
| | | It is sent from the DHCP authenticator to the |
| | | DHCP client. |
| DHCP NACK | EAP Failure | This message carries a corresponding EAP |
| (EAP-Message Option) | | message. |
| | | It is sent from the DHCP authenticator to the |
| | | DHCP client. |
| DHCP Release | — | This message indicates that a user is offline, and |
| | | that the corresponding session and IP address |
| | | should be released. |
| | | It is sent from the DHCP client to the DHCP |
| | | authenticator. |

TABLE 5

| DHCPv6 Message | EAP Message | Function Description |
|---|---|---|
| DHCP Solicit | — | 1. This message is broadcast to request the IP |
| (auth-proto Option) | | addresses of the DHCP authenticator and |
| | | DHCP server. The source IP address of this |
| | | message is 0.0.0.0. |
| | | 2. This message indicates the authentication |
| | | mode supported by the DHCP client. |
| | | It is sent from the DHCP client to the DHCP |
| | | authenticator. |
| DHCP Advertise | — | 1. This message is an authentication response |
| (auth-proto Option) | | returned by each DHCP authenticator, and |
| | | indicates the authentication mode supported |
| | | by each DHCP authenticator. |
| | | 2. This message provides an unleased IP |
| | | address and other DHCP configuration |
| | | information (such as subnet mask and |
| | | default gateway) for the DHCP client. |
| | | It is sent from the DHCP authenticator to the |
| | | DHCP client. |
| DHCP Request | — | 1. This message carries the authentication |
| (auth-proto Option) | | mode supported and the IP address |
| | | provided by the DHCP authenticator, |
| | | indicating that the DHCP client has |
| | | accepted the provided IP address and |
| | | DHCP authenticator. |
| | | It is sent from the DHCP client to the DHCP |
| | | authenticator. |
| DHCP Advertise | EAP | 1. This message is an authentication response |
| (auth-proto Option, | Request/Identity | returned by each DHCP authenticator, and |
| EAP-Message Option) | | indicates the authentication mode supported |
| | | by each DHCP authenticator. The |
| | | auth-proto Option is optional. |
| | | 2. This message provides an unleased IP |
| | | address and other DHCP configuration |
| | | information (such as subnet mask and |
| | | default gateway) for the DHCP client. |
| | | 3. This message carries a corresponding EAP |
| | | message. |
| | | It is sent from the DHCP authenticator to the |
| | | DHCP client. |
| DHCP Auth-response | EAP Request/ | This message carries a corresponding EAP |
| (EAP-Message Option)/ | Response | message. |
| DHCP EAP | | It is sent from the DHCP client to the DHCP |
| (EAP-Message Option) | | authenticator. |
| DHCP Auth-request | EAP Request/ | This message carries a corresponding EAP |
| (EAP-Message Option)/ | Response | message. |
| DHCP EAP | | It is sent from the DHCP authenticator to the |
| (EAP-Message Option) | | DHCP client. |
| DHCP Reply | EAP | 1. This message carries configurable network |
| (EAP-Message Option) | Success/Failure | parameters such as a user's IP address. |
| | | 2. This message carries a corresponding EAP |
| | | message. |
| | | It is sent from the DHCP authenticator to the |
| | | DHCP client. |
| DHCP Release | — | This message indicates that a user is offline, and |
| | | that the corresponding session and IP address |
| | | should be released. |
| | | It is sent from the DHCP client to the DHCP |
| | | authenticator. |

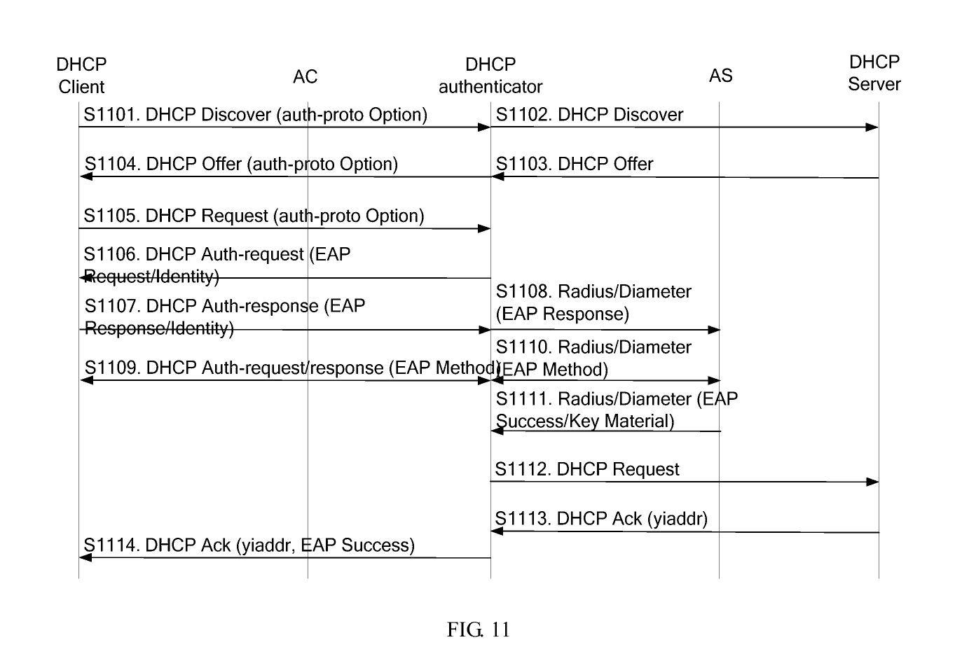

FIG. 11 is a flowchart of DHCP authentication through the new DHCPv4 messages and DHCP options in Table 4 according to the prior art. Steps S1101 to S1105 are the same as steps S501 to S505 in FIG. 5. The subsequent steps are as follows:

Step S1106: After receiving the DHCP Request message, the DHCP authenticator sends an EAP-Request/Identity message to the DHCP client. The EAP-Request/Identity message is carried in a DHCP Auth-request message or a DHCP EAP message.

Step S1107: After receiving the DHCP Auth-request or DHCP EAP message carrying the EAP-Request/Identity message, the DHCP client returns the EAP-Request/Identity message to the DHCP authenticator. The EAP-Request/Identity message is carried in a DHCP Auth-response message or a DHCP EAP message.

Step S1108: After receiving the EAP-Response/Identity message, the DHCP authenticator re-encapsulates the EAP-Response message into an AAA message and sends the message to the AS.

Step S1109: The DHCP client and the DHCP authenticator exchange EAP messages. The EAP messages exchanged between the DHCP client and the DHCP authenticator are carried in the DHCP Auth-request/response or DHCP EAP messages.

Step S1110: The DHCP authenticator and the AS exchange EAP messages. The EAP messages are carried in the AAA messages.

In step S1109 and step S1110, the EAP method negotiation and exchange are performed synchronously to check and verify the identity of the DHCP client. This process lasts until the EAP authentication ends.

Step S1111: The AS notifies the DHCP authenticator of the authentication success.

Step S1112: The DHCP authenticator constructs a DHCP Request message according to the recorded unleased IP address that is provided by the DHCP server for the DHCP client, and sends the message to the DHCP server.

Step S1113: The DHCP server assigns a global IP address and a real lease to the DHCP client according to the parameters in the DHCP Request message constructed by the DHCP authenticator, and returns a DHCP ACK message to the DHCP authenticator. The DHCP ACK message carries the EAP Success message and the IP address (yiaddr) assigned to the user.

Step S1114: After receiving the EAP Success message, the DHCP authenticator re-encapsulates the EAP Success message into a DHCP ACK message, and sends the message to the DHCP client. The DHCP ACK message carries the global IP address and the real lease assigned to the DHCP client.

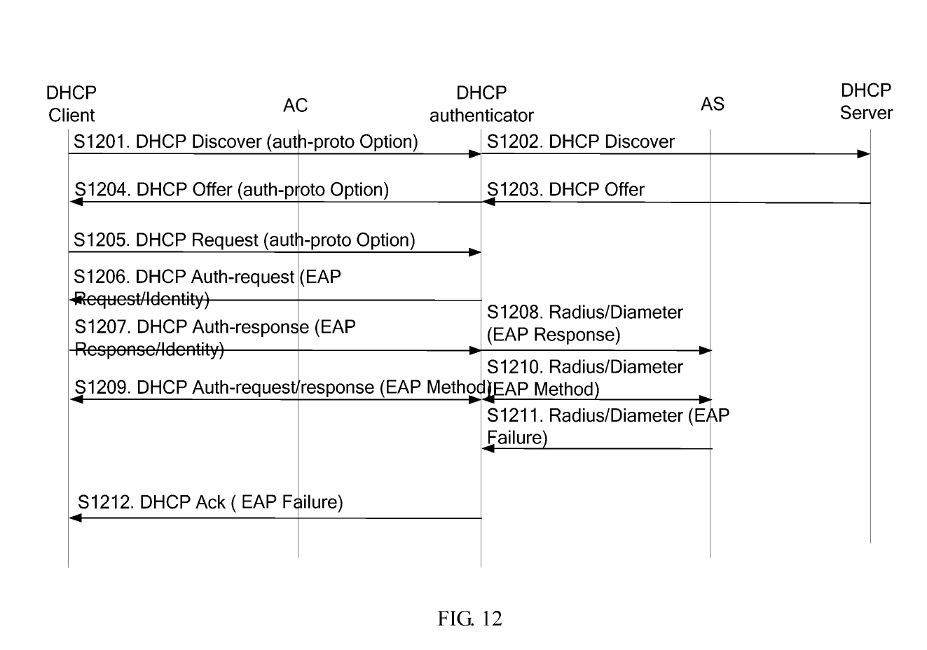

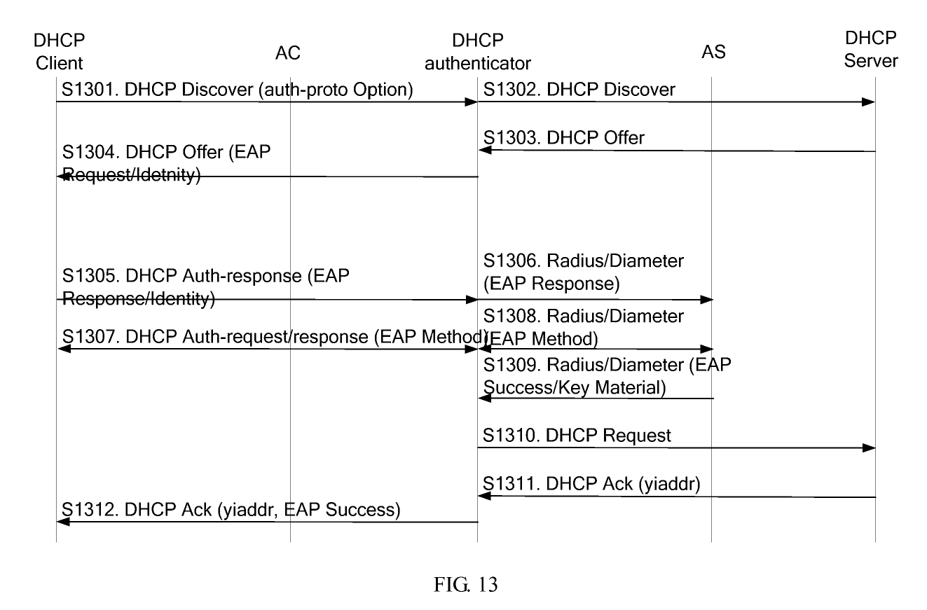

The EAP message and DHCP Option message are carried in the DHCP Auth-response and DHCP Auth-request messages or DHCP EAP messages. FIG. 12 is a flowchart of DHCP authentication in which the authentication fails. FIG. 13 is a simplified authentication flowchart. Details are omitted.

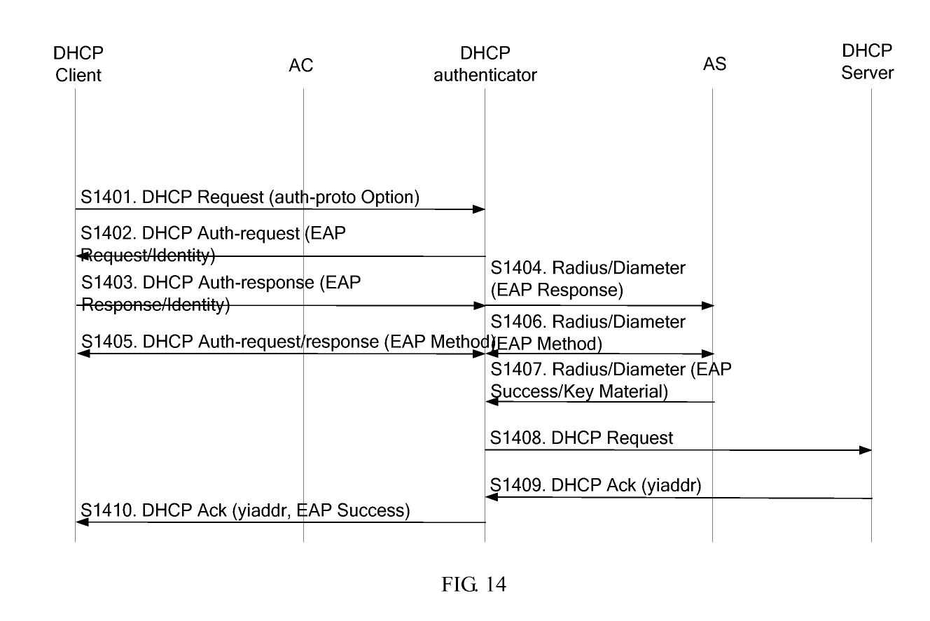

When the EAP message and DHCP Option message are carried in the DHCP Auth-response and DHCP Auth-request messages or the DHCP EAP messages, the DHCP client or the DHCP authenticator may trigger the re-authentication process after the authentication succeeds. FIG. 14 is a flowchart of re-authentication triggered by the DHCP client. In step S1401, the client directly sends a DHCP Request message. The DHCP Request message carries the authentication mode supported and the IP address provided by the DHCP authenticator, and indicates that the DHCP client selects the DHCP authenticator and accepts the IP address provided by the DHCP authenticator. The selected DHCP authenticator supports the authentication mode. In step S1402, after receiving the DHCP Request message, the authenticator performs identity authentication.

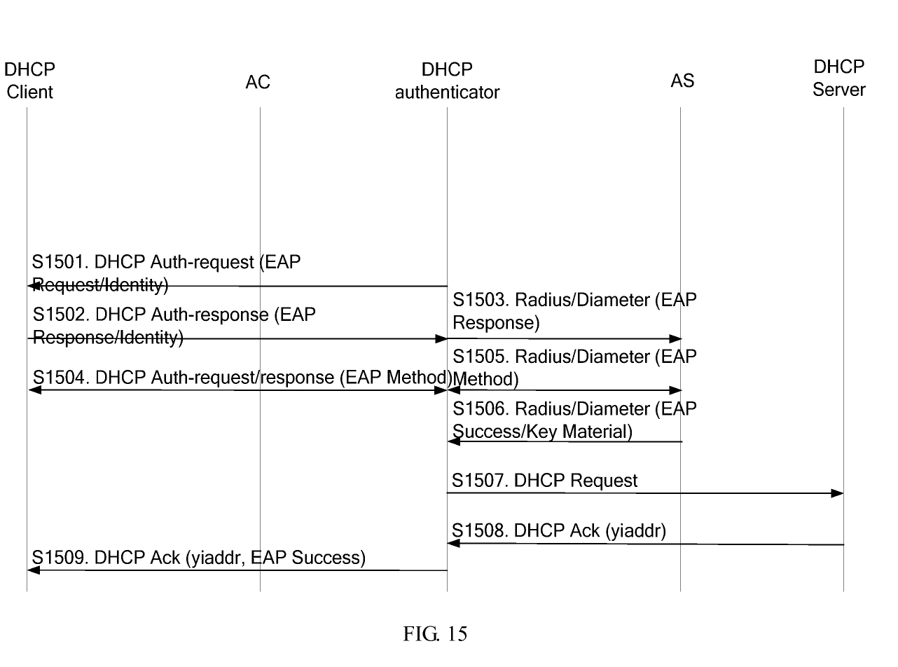

FIG. 15 is a flowchart of authentication triggered by the client. In step S1501, after the DHCP authentication succeeds, the authenticator sends an authentication request to the DHCP client to trigger re-authentication.

The authentication process through the new DHCPv4 messages and DHCP options is described above. Similarly, the authentication may be performed through the new DHCPv6 messages and DHCP options described in Table 5.

In addition, an embodiment of the present invention implements DHCP authentication by different combinations of DHCPv4/DHCPv6 messages and DHCP options. Table 6 describes the functions implemented by different combinations of DHCPv4 messages and DHCP options. Table 7 describes the functions implemented by different combinations of DHCPv6 messages and DHCP options.

| DHCPv4 Message | EAP Message | Function Description |
|---|---|---|
| DHCP Discover | — | 1. This message is broadcast to request the IP |
| (auth-proto Option) | | addresses of the DHCP authenticator and |
| | | DHCP server. The source IP address of this |
| | | message is 0.0.0.0. |
| | | 2. This message indicates the authentication |
| | | mode supported by the DHCP client. |
| | | It is sent from the DHCP client to the DHCP |
| | | authenticator. |
| DHCP Auth-response | EAP Request/ | This message carries a corresponding EAP |
| (EAP-Message | Response | message. |
| Option)/DHCP | | It is sent from the DHCP client to the DHCP |
| EAP(EAP-Message | | authenticator. |
| Option) | | |
| DHCP Auth-request | EAP Request/ | This message carries a corresponding EAP |
| (EAP-Message | Response | message. |
| Option)/DHCP | | It is sent from the DHCP authenticator to the |
| EAP(EAP-Message | | DHCP client. |
| Option) | | |
| DHCP Offer | EAP Success/ | 1. This message provides an unleased IP |
| (EAP-Message Option) | EAP Failure | address and other DHCP configuration |
| | | information (such as subnet mask and |
| | | default gateway) for the DHCP client. |
| | | 2. This message carries a corresponding EAP |
| | | message. |
| | | It is sent from the DHCP authenticator to the |
| | | DHCP client. |
| DHCP NACK | EAP Failure | This message carries a corresponding EAP |
| (EAP-Message Option) | | message. |
| | | It is sent from the DHCP authenticator to the |
| | | DHCP client. |
| DHCP Release | — | This message indicates that a user is offline, and |
| | | that the corresponding session and IP address |
| | | should be released. |
| | | It is sent from the DHCP client to the DHCP |
| | | authenticator. |
| DHCP Solicit | — | 1. This message is broadcast to request the IP |
| (auth-proto Option) | | addresses of the DHCP authenticator and |
| | | DHCP server. The source IP address of this |
| | | message is 0.0.0.0. |
| | | 2. This message indicates the authentication |
| | | mode supported by the DHCP client. |
| | | It is sent from the DHCP client to the DHCP |
| | | authenticator. |
| DHCP Auth-response | EAP Request/ | This message carries a corresponding EAP |
| (EAP-Message | Response | message. |
| Option)/DHCP | | It is sent from the DHCP client to the DHCP |
| EAP(EAP-Message | | authenticator. |
| Option) | | |
| DHCP Auth-request | EAP Request/ | This message carries a corresponding EAP |
| (EAP-Message | Response | message. |
| Option)/DHCP | | It is sent from the DHCP authenticator to the |
| EAP(EAP-Message | | DHCP client. |
| Option) | | |
| DHCP Advertise | EAP Success/ | 1. This message provides an unleased IP |
| (EAP-Message Option) | EAP Failure | address and other DHCP configuration |
| | | information (such as subnet mask and default |
| | | gateway) for the DHCP client. |
| | | 2. This message carries a corresponding EAP |
| | | message. |
| | | It is sent from the DHCP authenticator to the |
| | | DHCP client. |
| DHCP Reply | EAP Failure | 1. This message carries configurable network |
| (EAP-Message Option) | | parameters such as a user's IP address. |
| | | 2. This message carries a corresponding EAP |
| | | message. |
| | | It is sent from the DHCP authenticator to the |
| | | DHCP client. |
| DHCP Release | — | This message indicates that a user is offline, and |
| | | that the corresponding session and IP address |
| | | should be released. |
| | | It is sent from the DHCP client to the DHCP |
| | | authenticator. |

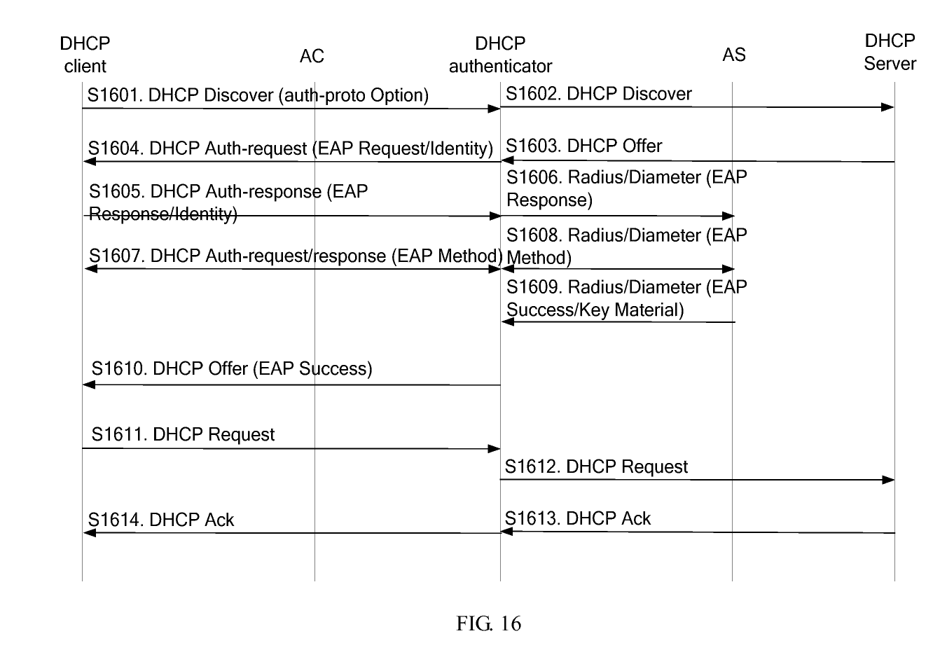

FIG. 16 is a flowchart of DHCP authentication through the new DHCPv4 messages and HDCP options listed in Table 6 according to the prior art. The process includes the following steps:

Step S1601: When connecting to the network, the DHCP client sends a DHCP Discover message to the network. This message indicates the DHCP authenticator and DHCP server involved in authentication and authorization. The auth-proto Option indicates the authentication mode supported by the DHCP client.

If the AC and the DHCP authenticator belong to different physical entities, the AC forwards the DHCP Discover message to the corresponding DHCP authenticator.

Step S1602: After receiving the DHCP Discover message, the DHCP authenticator forwards the message to the DHCP server.

Step S1603: The DHCP server checks the parameters in the DHCP Discover message and returns a DHCP Offer message to provide an unleased IP address and other DHCP configuration information (such as subnet mask and default gateway) for the DHCP client.

Step S1604: The DHCP authenticator sends an EAP-Request/Identity message to the DHCP client through a DHCP Auth-request message or a DHCP EAP message.

Step S1605: After receiving the DHCP Auth-request message or the DHCP EAP message, the DHCP client returns the EAP-Response/Identity message to the DHCP authenticator through a DHCP Auth-response message or a DHCP EAP message.

Step S1606: The DHCP authenticator forwards the received EAP-Response/Identity message to the AS through an EAP Response message over the AAA protocol.

Step S1607 and step S1608: The EAP method negotiation and exchange are performed. In these processes, the EAP messages exchanged between the DHCP client and the DHCP authenticator are carried in the DHCP Auth-request/response or DHCP EAP messages; the EAP messages exchanged between the DHCP authenticator and the AS are carried in the AAA messages. These processes last until the EAP authentication ends.

Step S1609: The AS notifies the DHCP authenticator of the authentication success.

Step S1610: After receiving the EAP Success message, the DHCP authenticator encapsulates the message into a DHCP Offer message and forwards the message to the DHCP client.

Steps S1611 to S1614 are the process of requesting a standard DHCP address in the prior art.

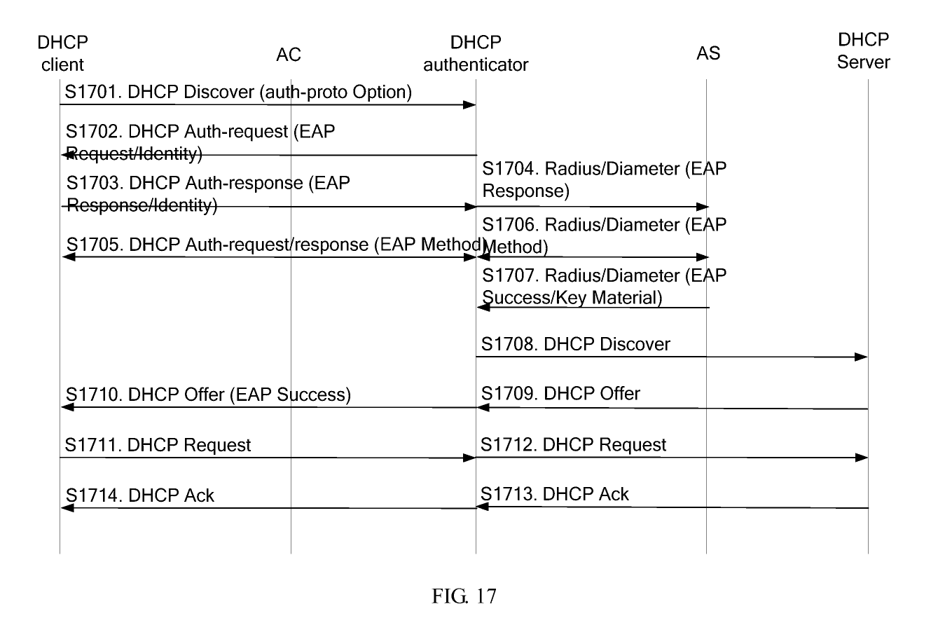

FIG. 17 is another flowchart of DHCP authentication through the new DHCPv4 messages and HDCP options listed in Table 6 according to the prior art. The process includes the following steps:

Step S1701: When connecting to the network, the DHCP client sends a DHCP Discover message to the network. This message indicates the DHCP authenticator involved in authentication. The auth-proto Option indicates the authentication mode supported by the DHCP client.

Step S1702: The DHCP authenticator sends an EAP-Request/Identity message to the DHCP client to provide an unleased IP address for the DHCP client. The DHCP server may also provide other DHCP configuration information such as subnet mask and default gateway for the DHCP client. The EAP-Request/Identity message is carried in a DHCP Auth-request message or a DHCP EAP message.

Step S1703: After receiving the DHCP Auth-request message or the DHCP EAP message, the DHCP client returns the EAP-Response/Identity message to the DHCP authenticator. The EAP-Response/Identity message is carried in a DHCP Auth-response message or a DHCP EAP message.

Step S1704: The DHCP authenticator forwards the received EAP-Response/Identity message to the AS over the AAA protocol.

Step S1705 and step S1706: The EAP method negotiation and exchange are performed. In these processes, the EAP messages exchanged between the DHCP client and the DHCP authenticator are carried in the DHCP Auth-request/response or DHCP EAP messages; the EAP messages exchanged between the DHCP authenticator and the AS are carried in the AAA messages. These processes last until the EAP authentication ends.

Step S1707: The AS notifies the DHCP authenticator of the authentication success.

Step S1708: The DHCP authenticator forwards the received DHCP Discover message to the DHCP server.

Step S1709: The DHCP server checks the parameters in the DHCP Discover message and returns a DHCP Offer message to provide an unleased IP address for the DHCP client. The DHCP server may also provide other DHCP configuration information (such as subnet mask and default gateway) for the DHCP client.

Step S1710: After receiving the DHCP Offer message, the DHCP authenticator encapsulates the EAP Success message into the DHCP Offer message and forwards the message to the DHCP client.

Steps S1711 to S1714 are the process of requesting a standard DHCP address in the prior art.

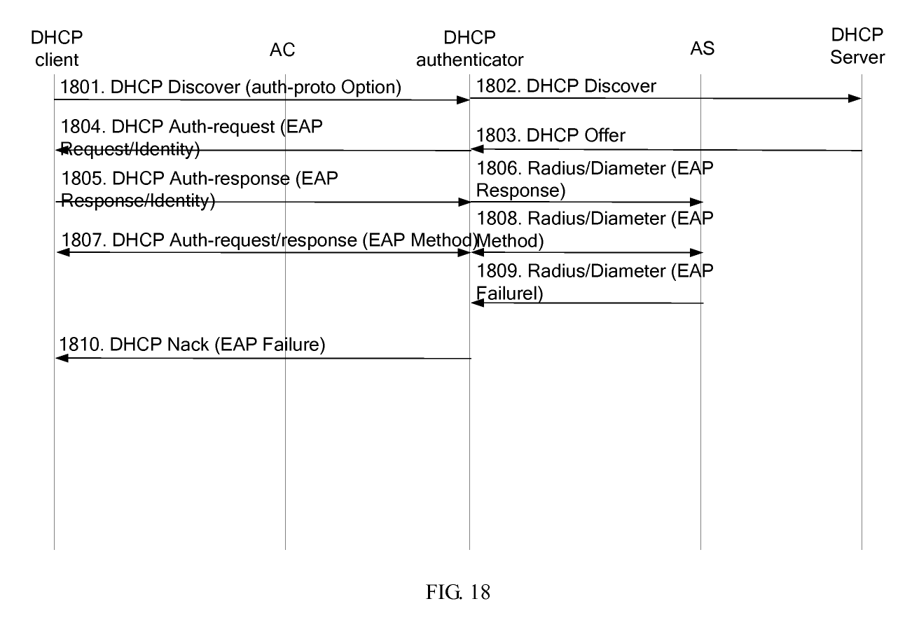

FIG. 18 is a flowchart of initial unsuccessful DHCP authentication through the new DHCPv4 messages and DHCP options listed in Table 6. The initial DHCP authentication process described in steps S1801 to S1808 is the same as that described in steps S1601 to S1608. The process after the AS authentication fails includes the following steps:

Step S1809: The DHCP authenticator receives an EAP Failure message sent by the AS.

Step S1810: The DHCP authenticator re-encapsulates the EAP Failure message into a DHCP NACK message or a DHCP Offer message, and forwards the message to the DHCP client.

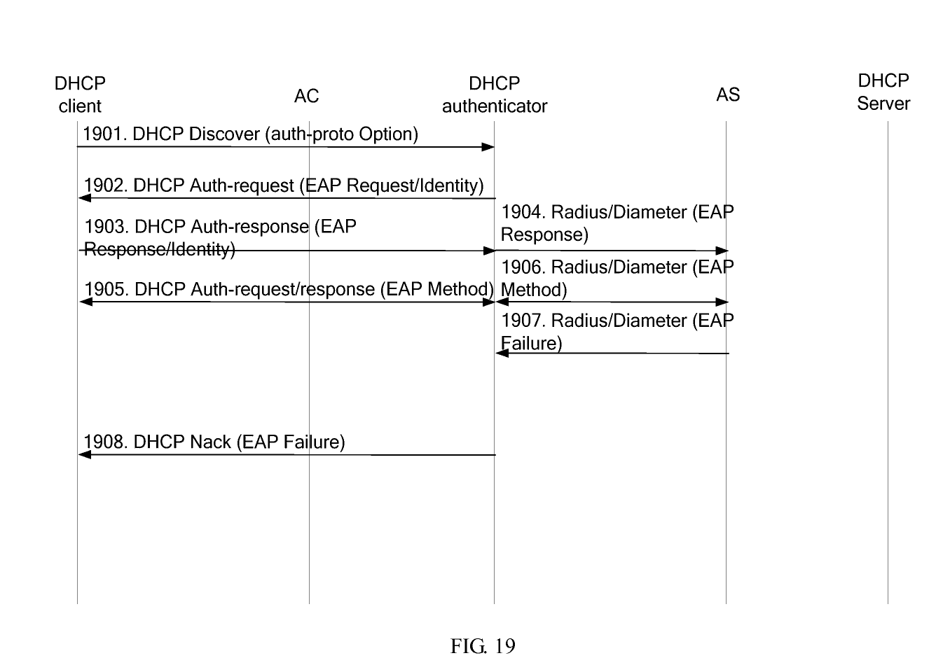

FIG. 19 is another flowchart of initial unsuccessful DHCP authentication through the new DHCPv4 messages and DHCP options listed in Table 6. The initial DHCP authentication process described in steps S1901 to S1906 is the same as that described in steps 1701 to 1706. The process after the AS authentication fails includes the following steps:

Step S1907: The DHCP authenticator receives an EAP Failure message sent by the AS.

Step S1908: The DHCP authenticator re-encapsulates the EAP Failure message into a DHCP NACK message or a DHCP Offer message, and forwards the message to the DHCP client.

The DHCPv4 authentication process implemented by different combinations of new DHCP messages and DHCP options is described above. Similarly, the DHCPv6 authentication process may be implemented by different combinations of new DHCP messages and DHCP options described in Table 7. Details are omitted here.

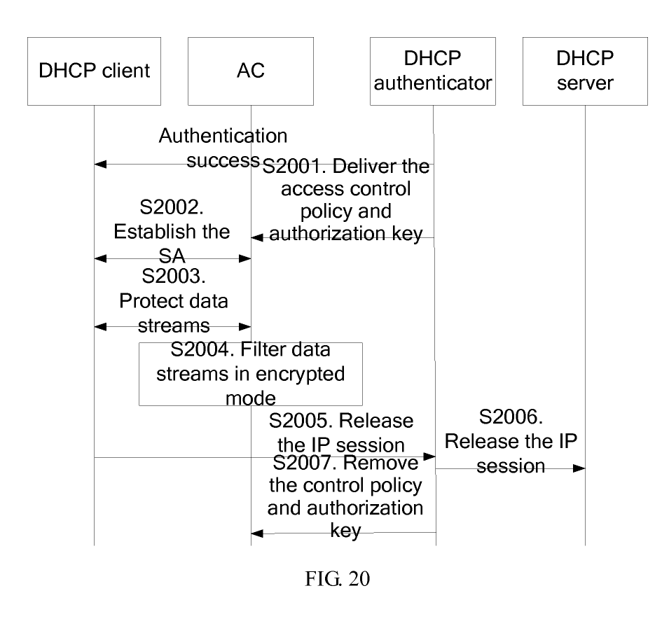

After the initial authentication or re-authentication succeeds, the DHCP client may connect to the network to access data. In this case, the AC is required to monitor the data streams of the client to ensure the data confidentiality during data sessions. During data sessions, the DHCP client and the DHCP authenticator may send IP session test data to detect the TTL of the IP sessions on the ports of the peer. FIG. 20 is a flowchart of filtering data streams in encrypted mode after the DHCP authentication succeeds. It includes the following steps:

After the authentication succeeds, the DHCP authenticator returns an EAP Success message to the DHCP client, and starts to perform step S2001 to interact with the AC.

Step S2001: The DHCP authenticator sends the access control policy and the authentication key of the DHCP client to the AC.

Step S2002: After receiving the access control policy and authentication key of the DHCP client, the AC establishes an SA with the DHCP client through the IKE, 802.11i 4WHS, or 802.16 3WHS protocol.

Step S2003: After the SA between the DHCP client and the AC is established, the AC uses the link-layer or network-layer encryption protocol to protect the data streams.

Step S2004: The AC filters out the unsecured messages from the data streams in encrypted mode.

Step S2005: When the entire IP session of the DHCP client ends, the DHCP client sends a DHCP Release message to the AS to terminate the IP session.

When detecting that the DHCP client disconnects the IP session due to incidents, the AC immediately sends a DHCP Release message to notify the DHCP authenticator of the IP session termination.

Step S2006: After receiving the DHCP Release message, the DHCP authenticator forwards the message to the DHCP server, and the DHCP server releases the IP address of the DHCP client.

Step S2007: After receiving the DHCP Release message, the DHCP authenticator requests the AC to remove the access control policy and authentication key of the DHCP client.

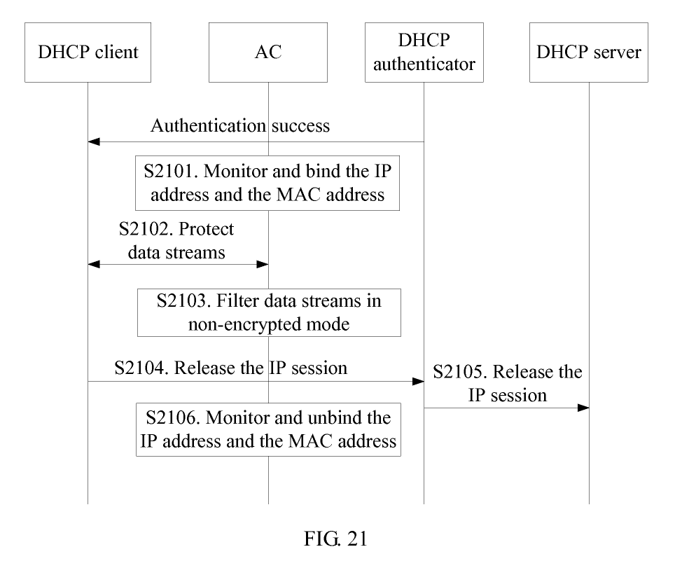

The process of filtering data streams in encrypted mode after the DHCP authentication succeeds is described above. An embodiment of the present invention implements data stream filtering in non-encrypted mode through the success message monitored by the AC after the authentication succeeds. FIG. 21 shows the flowchart. The process includes the following steps:

Step S2101: The AC monitors the DHCP messages, and binds the IP address and physical address (for example, MAC address) of the DHCP client when the EAP Success message is returned.

Step S2102: The DHCP client transmits data streams through the assigned IP address.

Step S2103: The AC filters out the packets in non-encrypted mode if the IP address of the DHCP client in the packets mismatches the user's MAC address.

Step S2104: When the entire IP session of the DHCP client ends, the DHCP client sends a DHCP Release message to the AC to terminate the IP session.

When detecting that the DHCP client disconnects the IP session due to incidents, the AC immediately sends a DHCP Release message to notify the DHCP authenticator of the IP session termination.

Step S2105: When detecting the DHCP Release message or the IP session link break, the AC unbinds the IP address and MAC address of the DHCP client.

Step S2106: The DHCP authenticator forwards the DHCP Release message to the DHCP server. The DHCP server releases the IP address of the DHCP client according to the received message.

To sum up, by setting multiple authenticators in the IP network to authenticate the DHCP client as an agent of the DHCP client, authentication is implemented without any change to the DHCP server; by setting temporary IP addresses during the authentication, the session authentication is implemented during the authentication, thus improving the stability, efficiency and success rate of the authentication. Embodiments of the present invention introduce ACs to separate the control plane from the data plane and support data access and filtering, thus ensuring the security of the data plane. The re-authentication mechanism is adopted for initiating re-authentication to reassign an IP address to the DHCP client for the IP session when the lease of the DHCP client is about to expire. The re-authentication process may be triggered by the DHCP client or the DHCP authenticator. The authentication method provided in embodiments of the present invention may be applied in IPv4 and IPv6 through different DHCP messages.

Although the technical solution of the present invention has been described through several exemplary embodiments, the invention is not limited to such embodiments. It is apparent that those skilled in the art can make various modifications and variations to the invention without departing from the scope of the invention. The invention is intended to cover the modifications and variations provided that they fall in the scope of protection defined by the claims or their equivalents.

What is claimed is:

1. A network access method, comprising:
receiving, by an access authenticator, a Dynamic Host Configuration Protocol, (DHCP) discover message sent by a client;
responding to the DHCP discover message with first configuration information used by the client during authentication, wherein the discover message is used to discover the access authenticator;
authenticating, by the access authenticator, the client locally or interacting with an authenticator server (AS) to authenticate the client remotely as an agent of the client; and
sending, by the access authenticator, a configuration request message to a configuration server to request second configuration information used by the client in an Internet Protocol (IP) session.

2. The method of claim 1, wherein the first configuration information comprises an IP address used by the client in a local network.

3. The method of claim 2, wherein the step of responding to the DHCP discover message comprises:
forwarding, by the access authenticator, the DHCP discover message to the configuration server;
receiving, by the access authenticator, a response message sent by the configuration server, wherein the response message carries an unleased IP address; and
replacing, by the access authenticator, the unleased IP address in the response message with the IP address used by the client in the local network and sending the message to the client.

4. The method of claim 1, further comprising:
monitoring packets or data streams transmitted or received by the client; and filtering the packets or data streams in non-encrypted or encrypted mode using a control policy during the session.

5. The method of claim 1, wherein:
the DHCP discover message carries an authentication mode supported by the client; and
the step of responding to the DHCP discover message comprises sending, by the access authenticator, an authentication mode supported by the access authenticator to the client.

6. The method of claim 1, wherein:
the access authenticator and the AS exchange messages through an Application Programming Interface (API) protocol when the access authenticator and the AS are located in a same physical entity.

7. The method of claim 1, wherein:
the access authenticator and the AS exchange messages through an Authentication, Authorization, and Accounting (AAA) protocol when the access authenticator and the AS are located in different physical entities.

8. The method of claim 1, wherein:
the access authenticator and the AS exchange messages through a Remote Authentication Dial in User Service (RADIUS) protocol when the access authenticator and the AS are located in different physical entities.

9. The method of claim 1, wherein:
the access authenticator and the AS exchange messages through a Diameter protocol when the access authenticator and the AS are located in different physical entities.

10. A network access system, comprising an access authenticator and a configuration server, wherein:
the access authenticator is configured to receive a discover message from a client, respond to the discover message with first configuration information used by the client during authentication, authenticate the client locally if the client is local, otherwise, interact with an Authentication Server (AS) to authenticate the client remotely as an agent of the client, and if the authentication succeeds, send a configuration request to the configuration server to request second configuration information used by the client in a session; and
the configuration server is configured to provide configuration information for the client, wherein the configuration information comprises at least the second configuration information.

11. The system of claim 10, wherein the first configuration information comprises an IP address used by the client in a local network.

12. The system of claim 11, further comprising:
an access controller, configured to monitor packets or data streams transmitted or received by the client, and filter the packets or data streams in non-encrypted or encrypted mode according to a control policy provided by the access authenticator, wherein the access controller and the access authenticator exchange messages through an API, Layer 2 Control Protocol (L2CP), or Simple Network Management Protocol (SNMP) interface.

13. The system of claim 10, wherein:
the discover message carries an authentication mode supported by the client; and
the access authenticator further sends an authentication mode supported by the access authenticator to the client.

14. An access authentication apparatus, comprising:
a first processing module, configured to receive a discover message sent by a client, obtain first configuration information used by the client during authentication, and respond to the discover message with the first configuration information to the client;
an authenticating module, configured to authenticate the client locally or interact with an authentication server (AS) to authenticate the client remotely as an agent of the client; and
a second processing module, configured to send a configuration request to a configuration server to request second configuration information used by the client during a session if the authentication succeeds.

15. The apparatus of claim 14, wherein the discover message carries a first authentication mode supported by the client, and the information sent to the client carries a second authentication mode supported by the access authentication apparatus.

16. The apparatus of claim 14, further comprising:
a re-authenticating module, configured to re-authenticate the client during the session to re-assign an IP address to the client.

17. The apparatus of claim 14, wherein the apparatus is a broadband access device, the broadband access device further comprises an interface, configured to send to an access controller a control policy that determines non-encrypted or encrypted filtering of packets or data streams transmitted and/or received by a client; and
wherein the interface comprises an API, L2C, or SNMP interface.
